(19) United States
(12) Patent Application Publication
(10) Pub. No.: US 2002/0085854 A1
(43) Pub. Date: Jul. 4, 2002

(54) Process cartridge, electric contact and electrophotographic image forming apparatus

(76) Inventors: Atsushi Numagami, Hadano-shi (JP); Kazunari Murayama, Shizuoka-ken (JP); Shigeru Hoashi, Numazu-shi (JP); Takahito Ueno, Mishima-shi (JP)

Correspondence Address: FITZPATRICK CELLA HARPER & SCINTO, 30 ROCKEFELLER PLAZA, NEW YORK, NY, 10112, US

(21) Appl. No.: 10/012,386

(22) Filed: Dec. 12, 2001

(30) Foreign Application Priority Data
Dec. 13, 2000 (JP) 378501/2000
Nov. 19, 2001 (JP) 353129/2001

(51) Int. Cl. G03G 15/00

(52) U.S. Cl. 399/90

(57) ABSTRACT

An electrical contact member, usable with a process cartridge, for establishing electrical connection between the process cartridge and a main assembly of an electrophotographic image forming apparatus, when the process cartridge is mounted to the main assembly of the apparatus, the process cartridge including an electrophotographic photosensitive drum and process means actable on the photosensitive drum, the electrical contact member including a base member; a mounting portion for mounting the base member to a frame of the process cartridge; a positioning portion for positioning the base member in the frame when the base member is mounted to the frame of the process cartridge by the mounting portion; an electrical contact portion, projected from the base member, for establishing electrical connection with a main assembly side electrical contact member, which is provided in the main assembly of the apparatus, by pressing in a direction against the main assembly side electrical contact member when the process cartridge is mounted to the main assembly of apparatus, wherein the direction is different from a mounting direction in which the process cartridge is mounted to the main assembly of the apparatus.

### FIELD OF THE INVENTION AND RELATED ART

The present invention relates to a process cartridge removably mountable in the main assembly of an electrophotographic image forming apparatus, electrical contacts therefor, and an electrophotographic image forming apparatus.

An electrophotographic image forming apparatus means an apparatus for forming an image on recording medium, with the use of an electrophotographic image formation process. The examples of an electrophotographic image forming apparatus include electrophotographic copying machines, electrophotographic printers (LED printers, laser beam printers, and the like), facsimile apparatuses, word processors, and the like.

A process cartridge means a cartridge, that is, a shell, in which a charging means, a developing means or a cleaning means, and an electrophotographic photoconductive drum as an image bearing member, are integrally placed, and which is removably mountable in the main assembly of an electrophotographic image forming apparatus. It also means a cartridge in which an electrophotographic photoconductive drum, and a minimum of one means among a charging means, a developing means, and a cleaning means, are integrally placed, and which is removably mountable in the main assembly of an electrophotographic image forming apparatus, and a cartridge, in which a minimum of a developing means and an electrophotographic image forming apparatus are integrally placed, and which is removably mountable in the main assembly of an electrophotographic image forming apparatus.

A developing apparatus means a cartridge in which a developer storage portion and a developing means are integrally placed, and which is removably mountable in the main assembly of an image forming apparatus.

An electrophotographic image forming apparatus employing an electrophotographic image formation process also employs a process cartridge system, in which an electrophotographic photoconductive member, and a single or a plurality of processing means which act on the electrophotographic photoconductive member, are integrally placed, and which is removably mountable in the main assembly of an electrophotographic image forming apparatus. Employment of a process cartridge system has significantly improved the operability of an electrophotographic image forming apparatus, and also, has made it possible for a user to easily maintain the aforementioned processing means. Thus, a process cartridge system is widely in use in the field of an electrophotographic image forming apparatus.

### SUMMARY OF THE INVENTION

Referring to FIGS. 12 and 13, the embodiments of the present invention, which were developed during the course of the development of the present invention, will be described. Incidentally, these embodiments have not been made public.

In order to make processing means (for example, development roller, charge roller, or charging process facilitation brush) within a cartridge 1, which is removably mountable in the main assembly of an electrophotographic image forming apparatus (which hereinafter will be referred to as apparatus main assembly (FIG. 1)), function, high voltage is necessary. Such high voltage is supplied to the cartridge 1 from the apparatus main assembly 100. Referring to FIG. 12, the surface of the leading end (front side in FIG. 12) of the cartridge 1, in terms of the direction in which the cartridge 1 is inserted into the apparatus main assembly 100, is provided with a contact 70. Referring to FIG. 13, the apparatus main assembly 100 is provided with a contact pin 95, which is kept pressed upon the contact 70 of the cartridge 1 by a contact spring 96 of the apparatus main assembly 100, in order to supply the processing means with voltage.

In order to ensure that the electrical contact between the apparatus main assembly 100 and cartridge 1 is maintained, the contact spring 96 needs to generate a contact pressure of several hundreds of gf (200 gf-500 gf). Further, when a plurality of processing means are contained in the cartridge 1, the contact 70 and contact pin 95 are needed by the count equal to that of the processing means. Thus, the sum of the contact pressures from all the contact springs 96 reaches the order of hundred ksf, reaching sometime several hundreds of ksf.

In order to simplify the process through which each contact pin 95 and the corresponding contact 70 are placed in contact with each other, the apparatus main assembly 100 and cartridge 1 are structured so that the contact pins 95 and contacts 70 are placed in contact with each other, by the movement of the process cartridge 1 made as the process cartridge 1 is mounted into the apparatus main assembly 100. Therefore, a contact pressure A acts upon the cartridge 1 in the direction counter to the direction D in which the cartridge 1 is mounted into the apparatus main assembly 100 (FIG. 13).

In a case that the contact pressure A, which is the contact pressure between a single contact and the corresponding contact pin, or the sum of the contact pressures between a plurality of contacts and a plurality of corresponding contact pins, acts in the direction counter to the cartridge mounting direction D, the cartridge 1 is subjected by the contact pressure A, to a substantial amount of pressure that acts in the direction to push the cartridge 1 out of the apparatus main assembly 100.

Therefore, in order to retain the cartridge 1 in a predetermined position within the apparatus main assembly 100, it is necessary to apply to the cartridge 1, such pressure that is large enough to cancel the substantial amount of contact pressure A applied to the cartridge 1 by the contact pin or pins. As for the member for holding the cartridge 1 from the opposite of the cartridge 1 with respect to the side to which the contact pressure A applies, it is possible use a lid 59 for covering the opening 100a, with which the apparatus main assembly 100 is provided to allow the cartridge 1 to be inserted into the apparatus main assembly 100.

When the process cartridge 1 is mounted into, or dismounted from, the apparatus main assembly 100, the lid 59 is placed in the position in which the opening 100a, with which the apparatus main assembly 100 is provided to insert the process cartridge 1 into the apparatus main assembly, is exposed. The lid 59 is structured so that it can be moved to expose or cover the opening 100a.

In order for the lid 59 to be able to cancel the aforementioned pressure A, the lid 59 itself must be given strength higher than a certain level, and also, the rotational axle 305, about which the lid 59 is rotated to be opened or closed, must be given strength higher than a certain level. Further, in order for a user to open or close the lid 59, the user must have strength sufficient to overcome the pressure A.

Referring to FIG. 1, in a case that the apparatus main assembly 100 is the apparatus main assembly of a color copying machine, it is equipped with a plurality of process cartridges 1Y, 1M, 1C, and 1K, the number of which matches the number of toners used by the apparatus. Referring to FIG. 6, when only a single lid 59 is used as the common lid for mounting or dismounting all the process cartridges, in other words, the mechanism related to the exposing or covering the opening 100a has been simplified, the lid 59 is relatively large, and is subjected to the sum of the all the contact pressures A generated by all the contacts 70 of all process cartridges and the corresponding contact pins 95. Therefore, the lid 59 for such an apparatus must be further increased in strength, compared to the lid of a monochromatic image forming apparatus.

The present invention was made to solve the above described problem.

The primary object of the present invention is to provide a combination of a process cartridge which is easy to mount into the apparatus main assembly of an electrophotographic image forming apparatus, and an electrophotographic image forming apparatus, which is compatible with such a process cartridge.

Another object of the present invention is to provide a combination of a process cartridge, electrical contacts, and an electrophotographic image forming apparatus, which is substantially smaller, compared to a conventional combination, in the load generated by the electrical contacts of the apparatus main assembly when the process cartridge is mounted into the apparatus main assembly.

Another object of the present invention is to provide a combination of a process cartridge, electrical contacts, and an electrophotographic image forming apparatus, which ensures that electrical connection is established and maintained between the process cartridge and the apparatus main assembly when the process cartridge is mounted into the apparatus main assembly.

Another object of the present invention is to provide a combination of a process cartridge, electrical contacts, and an electrophotographic image forming apparatus, which is substantially smaller, compared to a conventional combination, in the load to which the process cartridge is subjected when electrical connection is established and maintained between the electrical contacts of the process cartridge and the electrical contacts of the apparatus main assembly as the process cartridge is mounted into the apparatus main assembly.

Another object of the present invention is to provide: an electrical contact which establishes and maintains electrical connection between itself and the electrical contact, with which the main assembly of an image forming apparatus is provided, by pressing on the electrical contact of the apparatus main assembly in such a direction that is different from the direction in which the process cartridge is mounted into the apparatus main assembly; a process cartridge having such an electrical contact; and an electrophotographic image forming apparatus in which such a process cartridge is removably mountable.

According to an aspect of the present invention, there is provided an electrical contact member, usable with a process cartridge, for establishing electrical connection between the process cartridge and a main assembly of an electrophotographic image forming apparatus, when the process cartridge is mounted to the main assembly of the apparatus, the process cartridge including an electrophotographic photosensitive drum and process means actable on the photosensitive drum, said electrical contact member comprising a base member; a mounting portion for mounting said base member to a frame of the process cartridge; a positioning portion for positioning said base member in said frame when said base member is mounted to the frame of said process cartridge by said mounting portion; an electrical contact portion, projected from the base member, for establishing electrical connection with a main assembly side electrical contact member, which is provided in the main assembly of the apparatus, by pressing in a direction against the main assembly side electrical contact member when the process cartridge is mounted to the main assembly of apparatus, wherein said direction is different from a mounting direction in which the process cartridge is mounted to the main assembly of the apparatus.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a vertical sectional view of the main assembly of an electrophotographic color image forming apparatus in accordance with the present invention.

FIG. 2 is a vertical sectional view of a combination of a process cartridge and a toner supply container in accordance with the present invention.

FIG. 3 is a perspective view of the image forming apparatus main assembly, with its front door being open, and shows the general appearance thereof.

FIG. 4 is a sectional view of the process cartridge in accordance with the present invention, at a plane parallel to the lengthwise direction of the process cartridge.

FIG. 5 is a vertical sectional view of the toner supply container in accordance with the present invention, at a plane parallel to the lengthwise direction of the container.

FIG. 6 is a partially broken perspective view of the main assembly of an electrophotographic image forming apparatus in accordance with the present invention, showing how the process cartridge in accordance with the present invention is inserted in the apparatus main assembly through the cartridge mounting/dismounting opening of the apparatus main assembly.

FIG. 7 is a drawing for showing the concept of how electrical connection is established between a process cartridge and the main assembly of an electrophotographic image forming apparatus, in accordance with the present invention.

FIG. 8 is a drawing for showing the concept of how electrical connection is established between the high voltage contact of the process cartridge and the contact pin of the apparatus main assembly of the electrophotographic image forming apparatus, in one of the embodiments of the present invention.

FIG. 9 is a drawing for showing the concept of how electrical connection is established between the high voltage contact of the process cartridge and the contact pin of the apparatus main assembly of the electrophotographic image forming apparatus, in another embodiment of the present invention.

FIG. 10 is a perspective view of an electrical contact in accordance with the present invention.

FIG. 11 is a perspective view of the electrical contact attached to the frame of a process cartridge in accordance with the present invention.

FIG. 12 is an external perspective view of the process cartridge developed during the process which led to the present invention.

FIG. 13 is a drawing for showing the concept of how the process cartridge shown in FIG. 7 is electrically connected to the main assembly of an electrophotographic image forming apparatus in accordance with the present invention.

### DESCRIPTION OF THE PREFERRED EMBODIMENTS

Hereinafter, an electrophotographic color image forming apparatus in accordance with the present invention will be described with reference to the appended drawings In the following description of the present invention, the lengthwise direction means the direction parallel to the axial line of the electrophotographic photoconductive drum (which hereinafter will be referred to as photoconductive drum). Further, the side of a process cartridge or the apparatus main assembly, toward which the process cartridge is inserted, is referred to as rear side, and the side of the process cartridge or the apparatus main assembly, toward which the process cartridge is pulled out, is referred to as the front side. The top or bottom side of the process cartridge means the top or bottom side of the process cartridge when the process cartridge is in its proper position in the apparatus main assembly.

### Description of the General Structure of Image Forming Apparatus Main Assembly

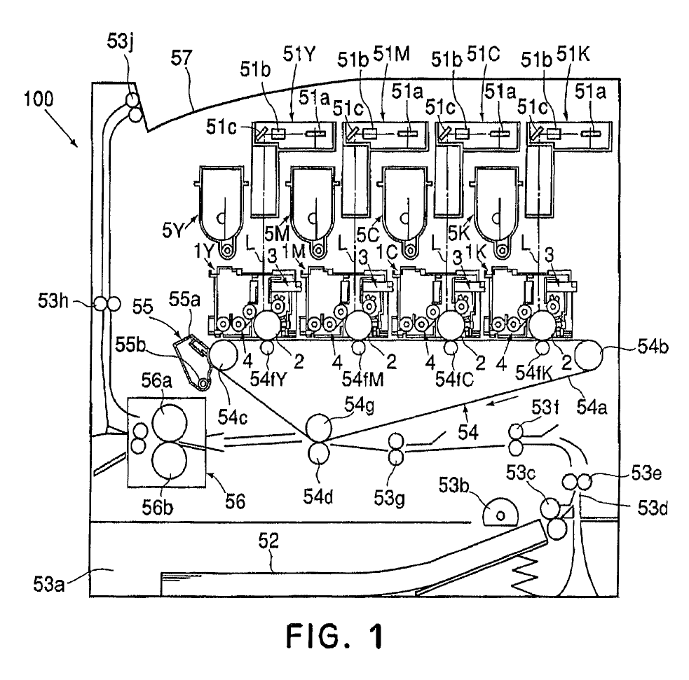

First, referring to FIG. 1, the general structure of an electrophotographic color image forming apparatus will be roughly described. FIG. 1 shows the general structure of a color laser beam printer, which is one of the various forms of an electrophotographic color image forming apparatus.

The image formation station of this printer is provided with four process cartridges 1Y (which contains toner of yellow color), 1M (which contains toner of magenta color), 1C (which contains toner of cyan color), and 1K (which contains toner of black color), each of which is equipped with a photoconductive drum 2. It is also provided with four exposing means (laser beam based optical scanning systems) 51Y, 51M, 51C, and 51K, which are disposed above the corresponding four process cartridges, in parallel to each other.

Below the aforementioned image formation stations a feeding/conveying portion for sending a recording medium 52 to the image forming station, an intermediary transfer belt 54a, onto which a toner image formed on the photoconductive drum 2 is transferred, a secondary transfer roller 54d for transferring the toner image on the intermediary transfer belt 54a onto the recording medium 52, are disposed.

In addition, a fixing means for fixing the unfixed toner image on the recording medium 52 to the recording medium 52, and a discharging means for discharging the recording medium 52 out of the apparatus main assembly and placing it on the preceding recording medium 52, are disposed below the image formation station. At this time, the structure of each of the above described portions of the image forming apparatus will be described in detail in the logical order.

### Feeding/Conveying Portion

The feeding/conveying portion is a portion for feeding the recording medium 52 to the image formation station. It comprises a feeder cassette 53a, in which a plurality of recording media 52 are stored in layers, a feeder roller 53g, a retarding roller 53c for preventing two or more recording media 52 from being fed at the same time, a recording medium guide 53d, and a registration roller 53g.

The feeder roller 53b rotates in synchronism with an image forming operation, and feeds the recording media 52 into the apparatus main assembly, one by one, out of the cassette 53a. The recording media 52 are prevented by the retarding roller 53c from being conveyed in layers. Each recording medium 52 is conveyed to the registration roller 53g, past conveyer rollers 53e and 53f, being guided by the recording medium guide 53d.

The moment the recording medium 52, which is being conveyed to the registration roller 53g, comes into contact with the registration roller 53g, the registration roller 53g is not being rotated. Thus, if the recording medium 52 is skewed, it is straightened as it comes into contact with the registration roller 53g.

During an image forming operation, the registration roller 53g repeats a predetermined sequence consisting of a nonrotational state in which it keeps the recording medium 52 on standby, and a rotational state in which it conveys the recording medium 52 toward the transfer belt 54a; in other words, the registration roller 53g controls the conveyance of the recording medium 52 so that a toner image and the recording medium 52 align with each other during the transfer process.

### Process Cartridge

The process cartridges 1Y, 1M, 1C, and 1K each comprise a photoconductive drum 2, a charging means, and a developing means, which are integrally disposed in a shell, that is, cartridge, in such a manner that the charging means and developing means are located close to the peripheral surface of the photoconductive drum 2. The process cartridge 1 can be easily removed by a user from the main assembly (which hereinafter will be referred to as apparatus main assembly 100) of an electrophotographic image forming apparatus. The process cartridge 1 is replaced as the service life of the photoconductive drum 2 expires. In this embodiment, the number of the rotations of the photoconductive drum 2 is counted, and as the number of the rotations exceeds a predetermined value, it is indicated that the service life of the process cartridge 1 has expired.

The photoconductive drum 2 in this embodiment is an organic photoconductive member, which is charged to the negative polarity. It comprises a hollow aluminum drum 2h an a base member, which is approximately 30 mm in diameter, an ordinary photoconductive layer covering the peripheral surface of the base member 2h, and a charge injection layer as the outermost layer, which is covering the photoconductive layer. The photoconductive drum 2 is rotationally driven at a predetermined process speed, which in this embodiment is approximately 117 mm/sec.

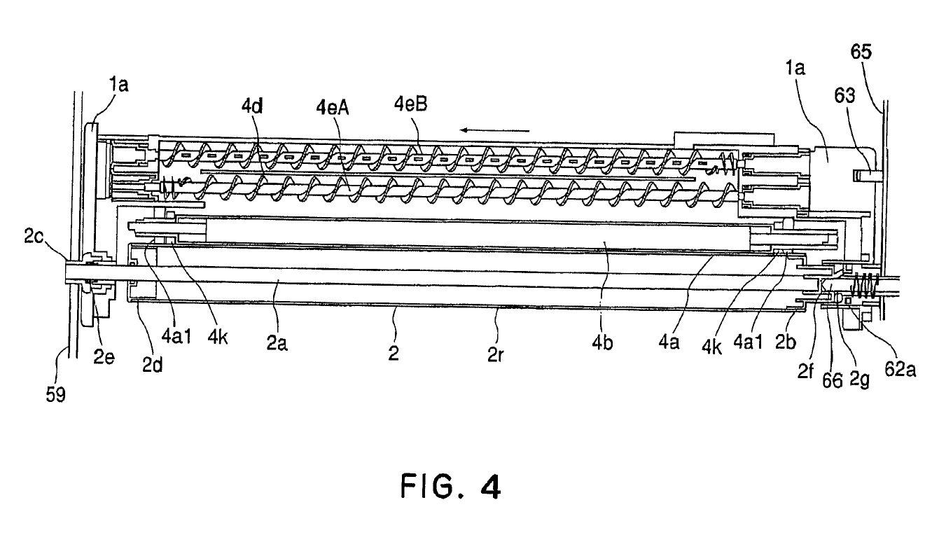

Referring to FIG. 4, the photoconductive drum 2 is provided with a drum flange 2b and a non-driven flange 2d, which are fixed to the rear and front ends (right and left end in FIG. 4), respectively, of the photoconductive drum 2 in terms of the lengthwise direction. The photoconductive drum 2 is also provided with a drum shaft 2a, which is put through the flanges 2b and 2d in such a manner that the axial line of the drum shaft 2a coincides with the axial lines of the flanges 2b and 2d. The drum shaft 2a and flange 2d are engaged with each other so that they integrally rotate. The base member 2h, drum shaft 2a, and flange 2b, integrally rotate. In other words, the photoconductive drum 2 rotates about the axial line of the drum shaft 2a.

The front end of the shaft 2a is rotationally supported by a bearing 2e, which is fixed to a bearing case 2c, which is fixed to the frame 1a of the cartridge 1.

### Charging Means

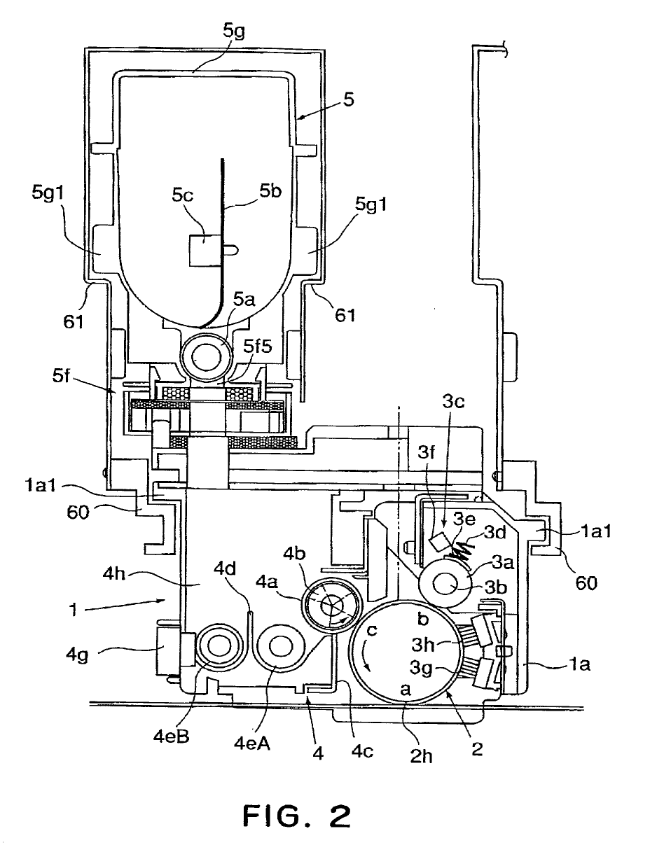

The charging means is such a charging means that employs a contact charging method. Referring to FIG. 2, in this embodiment, a charge roller 3a is used as a charging member. The ends of the metallic core 3b of the charging roller 3a are rotationally supported, one for one, by bearings (unshown), Further, the bearing member is kept pressed by a compression coil spring 3d toward the axial line of the photoconductive drum 2. Consequently, the charge roller 3a is kept pressed upon the peripheral surface of the photoconductive drum 2, generating a predetermined amount of contact pressure. The charge roller 3a is rotated by the rotation of the photoconductive drum 2.

Designated by a referential code 3e is a member for cleaning the charge roller 3a. In this embodiment, the charge roller cleaning member 3e comprises a supporting member 3f, and a flexible cleaning film 3e attached to the supporting member 3f. In length, the flexible film 3e virtually matches the charge roller 3a, and extended in the direction parallel to the lengthwise direction of the charge roller 3a. More specifically, the supporting member 3f is enabled to oscillate within a certain range in terms of the lengthwise direction, and the flexible film 3e is attached to the supporting member 3f, by one of its long edges. The surface of the film 3e adjacent to the free long edge of the film 3e forms a contact nip against the charge roller 3a. As the supporting member 3f is oscillated by a driving means (unshown) in the lengthwise direction, the peripheral surface of the charge roller 3a is rubbed by the film 3e. Consequently, the deposits (microscopic toner particles, external additives, and the like) adhering to the peripheral surface of the charge roller 3a are removed.

In this embodiment, a residual toner particle (residual developer image) redistributing means 3g for evenly redistributing across the peripheral surface of the photoconductive drum 2, the transfer residual toner particles on the photoconductive drum 2, that is, the toner particles remaining on the peripheral surface of the photoconductive drum 2 after the primary image transfer, is provided on the downstream side in terms of the rotational direction of the photoconductive drum 2, with respect to the transfer station a. Further, on the downstream side in terms of the rotational direction of the photoconductive drum 2, with respect to the residual toner particle redistributing means 3g, and on the upstream side in terms of the rotational direction of the photoconductive drum 2, with respect to the charging station b, a toner (developer) charge controlling means 3h (auxiliary charging brush) is provided, which is for making all the residual toner particles uniform in polarity, being charged to the normal polarity, or the negative polarity.

With the provision of the residual toner particle redistributing means 3g, even if a significant amount of toner particles are left on the peripheral surface of the photoconductive drum 2 after the primary image transfer, they are evenly redistributed across the peripheral surface of the photoconductive drum 2 as they are conveyed from the transfer station a to the charge controlling means 3h. Therefore, it does not occur that the residual toner particles concentrate to certain portions of the charge controlling means 3h. Therefore, all the residual toner particles are satisfactorily charged by the charge controlling means 3h to the normal polarity, being thereby effectively prevented from adhering to the charge roller 3a.

In this embodiment, the residual toner particle redistributing means 3g and toner charge controlling means 3h are in the form of a brush, and have a proper level of electrical conductivity. Their brush portions are in contact with the peripheral surface of the photoconductive drum 2.

Further, these means are moved (oscillated) by a single or a plurality of driving force sources (unshown) in the direction parallel to the lengthwise direction of the photoconductive drum 2.

### Exposing Means

In this embodiment, the photoconductive drum 2 is exposed by a laser based exposing means. More specifically, as image data signals are sent to the laser based exposing means from the apparatus main assembly 100, a beam L of laser light modulated with the image data signals is projected onto the charged peripheral surface of the photoconductive drum 2, in a manner to scan the peripheral surface of the photoconductive drum 2. As a result, an electrostatic latent image in accordance with the image data signals is formed on the peripheral surface of the photoconductive drum 2.

Referring to FIG. 1, the exposing means comprises a laser element (unshown), a polygon mirror 51a, a focusing lens 51b, and a reflection mirror 51c. The laser element is turned on or off by a light emission signal generation device (unshown), with a predetermined timing, in response to the inputted image data signals. The laser beam L emitted from the laser element is reflected by the polygon mirror 51a in a manner to produce a scanning movement, and is focused on the peripheral surface of the photoconductive drum 2 through the focusing lens 15b and reflection mirror 51c.

### Developing Apparatus

The developing apparatus 4 in this embodiment is a contact type developing apparatus which employs two component developer (two component magnetic brush type developing apparatus). Referring to FIG. 2, the developer, which is a mixture of carrier and toner, is borne on the peripheral surface of a development roller 4a as a developing means, which contains a magnetic roll 4b in its hollow. The developing apparatus 4 is provided with a regulator blade 4c, which is disposed adjacent to the peripheral surface of the development roller 4a, holding a predetermined gap relative to the peripheral surface of the development roller 4a. It forms a thin layer of the developer on the peripheral surface of the development roller 4a, as the development roller 4a is rotated in the direction indicated by an arrow mark. Incidentally, in this embodiment, a two component magnetic brush type developing apparatus is employed as the developing apparatus However, developing apparatus selection does not need to be limited to the one utilized in this embodiment.

Referring to FIG. 4, the development roller 4a is provided with a pair of journal portions 4a1, which are attached to the lengthwise ends of the development roller 4a, one for one. Each journal portion 4a1 is fitted with a spacer ring 4k, which is greater in radius, by an amount equal to the development gap, than the development roller 4a. The gap between the peripheral surfaces of the development roller 4a and photoconductive drum 2, in which a magnetic brush is formed, is created by placing the spacer ring 4k in contact with the peripheral surface of the photoconductive drum 2. Referring to FIG. 2, the development roller 4a is rotationally driven in the direction indicated by an arrow mark. Consequently, the peripheral surface of the development roller 4a moves in the direction counter to the moving direction of the peripheral surface of the photoconductive drum 2, in the development station c.

The developer used in this embodiment is a mixture of toner and carrier. The mixing ratio between the toner and carrier is 6:94 in weight ratio. Developer selection does not need to be limited to the mixture of toner and magnetic carrier. Instead, magnetic toner may be employed.

Referring to FIG. 2, the developer storage portion 4h in which the developer is stored has two portions separated by a partitioning wall 4d, which extends in the lengthwise direction. The two portions separated by the partitioning wall 4d are provided with a pair of stirring screws 4eA and 4eB, one for one, which are disposed in a manner to sandwich the partitioning wall 4d.

Referring to FIG. 4, after being supplied from a toner supply container 5, toner fall onto the rear end of the screw 4eB (right end in FIG. 4), and is conveyed in the lengthwise direction toward the front (left end in FIG. 4), while being stirred by screw 4eB. At the front end of the developer storage portion 4h, the toner is moved into the portion with the screw 4eA, past the gap between the front end of the partition wall 4d and the front wall of the toner storage portion 4h. Then, the toner is sent back to the rear end (right end in FIG. 4) in terms of the lengthwise direction, by the screw 4eA. At the rear end, the toner is moved back into the portion with the stirring screw 4eB, past the gap between the rear end of the partitioning wall 4d and the rear wall of the toner storage portion 4h, to be conveyed again by the screw 4eB toward the front end while being stirred. In other words, the toner is circulated in the toner storage portion 4h as described above.

At this time, referring to FIG. 2, the development process for developing an electrostatic latent image on the photoconductive drum 2, with the use of the developing apparatus 2 along with the two component magnetic brush based developing method, and the developer circulation system, will be described. As the development roller 4a is rotated, the developer in the developer storage portion 4h is picked up by the magnetic roll 4b, onto the peripheral surface of the development roller 4a, and is conveyed.

While being conveyed, the developer layer on the peripheral surface of the development roller 4a is regulated in thickness by the regulator blade 4c disposed adjacent to the development roller 4a in a manner to hold a predetermined gap relative to the peripheral surface of the development roller 4a. As a result, a thin layer of the developer with a predetermined thickness is formed on the peripheral surface of the development roller 4a. As the portion of the developer on the peripheral surface of the development roller 4a, the thickness of which has been regulated, is conveyed to a location correspondent to the development pole of the magnetic roll 4b, the location of which corresponds to the location of the development station c, the developer particles are agglomerated in the form of a broom tip by the magnetic force. The electrostatic latent image on the peripheral surface of the photoconductive drum 2 is developed into a toner image by the toner particles in the agglomeration of the developer particles in the form of a broom tip.

The developer particles in the portion of the developer layer on the development roller 4a, which has passed the development station c, enter the developer storage portion 4h as the development roller 4a is further rotated. Entering the developer storage portion, they are made to separate from the peripheral surface of the development roller 4a, by the repulsive magnetic field from the conveyance pole, and fall into the developer storage portion 4h.

To the development roller 4a, a combination of DC voltage and AC voltage is applied from an electric power source (unshown). In this embodiment, a combination of a DC voltage of 500 V, and an AC voltage with a frequency of 2,000 Hz and a peak-to-peak voltage of 1,500 V, is applied to the development roller 4a.

As the toner is consumed by development, the toner content (ratio) of the developer reduces. Thus, in this embodiment, a sensor 4g for detecting the toner ratio of the developer is provided as shown in FIG. 2; the sensor 4g detects the state of the developer, in which the toner ratio is lower than a predetermined level. As the sensor 4g detects that the toner ratio of the developer has fallen below the predetermined level, toner is supplied to the toner storage portion 4h from the toner supply container 5. The toner ratio of the developer is always kept at a predetermined level by this toner supplying operation.

### Toner Supply Container

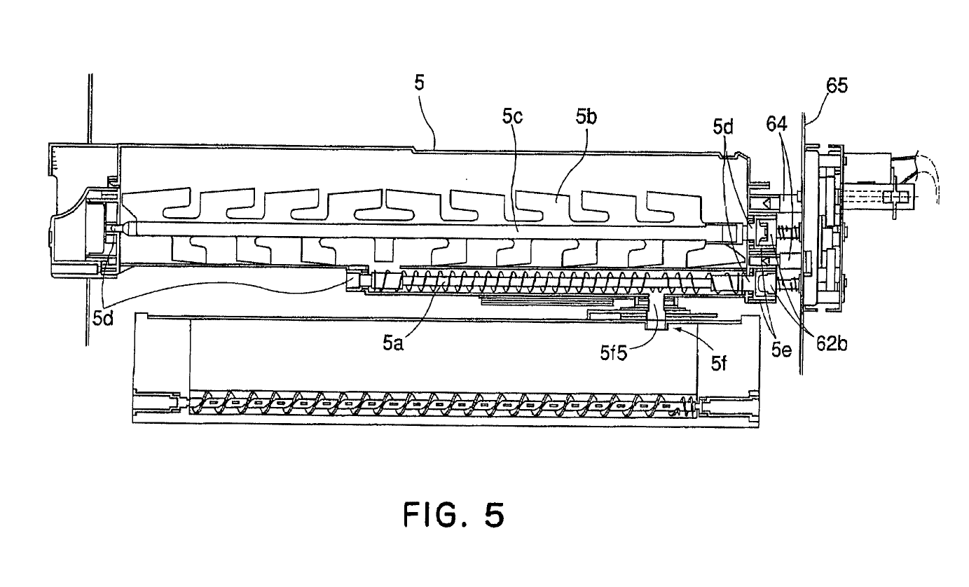

The toner supply containers 5Y, 5M, 5C, and 5K are parallelly disposed above the cartridges 1Y, 1M, 1C, and 1K, correspondingly. They are mounted into the apparatus main assembly 100 from the front side of the apparatus main assembly 100. Referring to FIG. 2, each toner supply container 5 holds toner or a mixture of toner and magnetic carrier, in its frame 5g, that is, the toner storage portion (developer storage portion). The toner supply container 5 is provided with a stirring shaft 5c, stirring plates 5b fixed to the stirring shaft 5c, and a screw 5a. It is also provided with an outlet 5f, which is at the bottom of the container 5, and by which it is connected to the cartridge 1. Referring to FIG. 5, the screw 5a and stirring shaft 5c are rotationally supported by bearings 5d, by their lengthwise ends, one for one. At the rear end (right end in FIG. 5), a coupling 5e (female type) is provided, which receives driving force from a coupling (male type) 62b on the apparatus main assembly 100 side, and is rotationally driven by the driving force. The screw 5a is rotated in a predetermined rotational direction by the rotation of the coupling (male type) 62b, and conveys the toner toward the outlet 5f, eventually causing the toner to free fall from the first opening 5f5 with which the outlet 5f is provided. Thus, the cartridge 1 is supplied with the toner.

### Transferring Means

The intermediary transfer unit 54 as a transferring means is shown in FIG. 1. This unit 54 transfers (secondary transfer) all at once onto the recording medium 5w, the plurality of toner images having been transferred (primary transfer) in layers onto a belt 54a from the photoconductive drum 2.

The unit 54 is provided with the belt 54a which runs in the direction indicated by an arrow. The belt 54a runs in the direction of the arrow at approximately the same peripheral velocity as that of the photoconductive drum 2. It is an endless belt, and is stretched around three rollers: a driver roller 54b, a secondary transfer counter roller 54g, and a follower roller 54c.

Further, on the inward side of the loop of the belt 54a, transfer charge rollers 54fY, 54fM, 54fC, and 54fK are rotationally disposed on the locations at which their peripheral surfaces oppose the peripheral surface of the photoconductive drum 2, being kept pressured toward the axial line of the photoconductive dram 2.

Each transfer charge roller is supplied with electrical power, by a high voltage power source (unshown), and charges the belt 54a to the polarity opposite to that of the toner, from the back side, that is, inward side of the belt 54a, with reference to the loop of the belt 54a. As a result, the toner images on the photoconductive drums 2 are transferred (primary transfer) onto the top surface of the belt 54a, one after another, in layers.

In the secondary transfer station, the secondary transfer roller 54d as a transferring member is disposed at the location which corresponds to the location of the roller 54g. During a transfer process, the secondary transfer roller 54d is kept pressed upon the belt 54a toward the roller 54g. The roller 54d, which is rotatable, is movable in the vertical direction in FIG. 1. In order to prevent the image or images on the belt 54a from being disturbed by the secondary transfer roller 54d, the secondary transfer roller 54d is kept away from the belt 54a, until a multicolor image is completed on the belt 54a by the sequential transfer of the monochromatic toner images onto the belt 54a.

The belt 54a and roller 54d are driven independently from each other. As the recording medium 52 enters the secondary transfer station, a predetermined bias is applied to the roller 54d. As a result, the monochromatic toner images on the belt 54a are transferred (secondary transfer) onto the recording medium 52.

After the completion of the transfer process, the recording medium 52 is conveyed in the leftward direction in FIG. 1 to a fixing device 56, in which the next process is carried out.

The apparatus main assembly 100 is provided with a cleaning unit 55 for removing the toner particles remaining on the belt 54a after the secondary transfer. The cleaning unit 55 is disposed at the location correspondent to a predetermined point of the loop of the belt 54a, and is enabled to be placed in contact with, or moved away from, the surface of the belt 54a.

Referring to FIG. 1, within the cleaning unit 55, a cleaning blade 55a for removing toner particles is disposed. The unit 55 is mounted so that it can be pivoted about a pivotal center (unshown). The blade 55a is kept pressed upon the belt 54a, being tilted so that the functional edge of the blade 55a is on the upstream side in terms of the rotational direction of the belt 54a, with respect to the base of the blade 55a. After being collected into the unit 55, the toner particles are conveyed by the screw 55b into a removed toner particle container (unshown) and are stored therein.

### Fixing Station

As described above, after being formed on the photoconductive drum 2 by the developing means, the toner image is transferred onto the recording medium 52 by way of the belt 54a. Then, the fixing device 56 fixes the toner image on the recording medium 52, to the recording medium 52 with the use of heat and pressure.

Referring to FIG. 1, the fixing device 56 is provided with a fixing roller 56a and a pressure roller, for applying heat to the recording medium 52. Each roller contains a heater (unshown).

After the fixing, the recording medium 52 is discharged from the apparatus main assembly 100, by discharge rollers 53h and 53j, to be accumulated in a delivery tray 57 of the apparatus main assembly 100.

### Mounting of Process Cartridge and Toner Supply Container

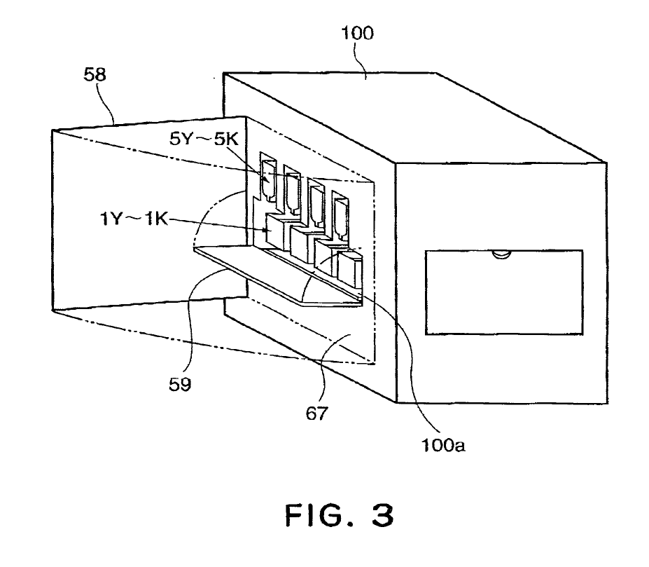

Next, referring to FIGS. 2-5, the steps to be followed to mount the cartridge 1 and toner supply container 5 into the apparatus main assembly 100 will be described. FIG. 3 is a schematic external perspective view of the apparatus main assembly 100. As shown in FIG. 3, the front wall of the apparatus main assembly 100 is provided with a front door 100a (opening/closing member) which can be opened or closed by an operator. AS this door 58 is opened toward the front, the opening 100a is exposed, through which the cartridges 1Y-1K, and toner supply containers 5Y-5K, are inserted. The opening 100a is in the front plate (wall) 67 of the apparatus main assembly 100.

The apparatus main assembly 100 is also provided with a lid (opening/closing member), which is rotatable attached to the bottom edge of the opening 100a. In order to mount or dismount the cartridge 1, this lid 59 must be first opened. Referring to FIG. 2, within the apparatus main assembly 100, a pair of guide rails 60 for guiding the mounting guides 1a1 of the cartridge 1, and a pair of guide rails 62 for guiding the mounting guides 5g1 of the toner supply container 5, are disposed. The mounting guides 1a1 are integral parts of the frame 1a of the cartridge 1, and are parallel to the axial line of the photoconductive drum 2.

In this embodiment, both the front door 58 and lid 59 are provided as members which can be opened or closed. However, provision of only one member, that is, either the front door 58 or lid 59, suffices.

The direction in which the cartridge 1 and toner supply container 5 are mounted into the apparatus main assembly 100 is parallel to the axial line of the photoconductive drum 2, and so are the directions in which the guide rails 60 and 61 are extended. The cartridge 1 and toner supply container 5 are inserted in the apparatus main assembly 100 from the front side of the apparatus main assembly 100, and are slid toward the rear side of the apparatus main assembly 100.

Referring to FIG. 4, as the cartridge 1 is inserted to the deepest end of the apparatus main assembly 100, the shaft 66 of the apparatus main assembly 100 fits into the center hole 2f of the drum flange 2b. At the same time, the driving force transmitting portion 2g becomes connected to the driving coupling (female type) 62a, enabling the photoconductive drum 2 to be rotationally driven.

Also referring to FIG. 4, the rear plate 65 of the apparatus main assembly 100 is provided with a cartridge supporting pin 63 for accurately positioning the cartridge 1 relative to the apparatus main assembly; the position of the cartridge 1 relative to the apparatus main assembly is fixed as the supporting pin 65 fits into the frame 1a of the cartridge 1.

Further, the lid 59 engages with the bearing case 2c of the cartridge 1, as shown in FIG. 4. As a result, the cartridge 1 becomes precisely supported in the predetermined position in the apparatus main assembly. Through the above described cartridge insertion sequence, the photoconductive drum 2 and cartridge 1 relative to the apparatus main assembly are precisely fixed in their positions relative to the apparatus main assembly

As for the toner supply container 5, it is also inserted into the deep end of the apparatus main assembly 100 as is the cartridge 1, and is fixed to a supporting pin 64 projecting from the rear plate 65. At the same time, the coupling (female type) 5e becomes connected to the coupling (male type) 62b, enabling the screw 5a and stirring shaft 5c to be rotationally driven.

### Embodiments of Electrical Contacts

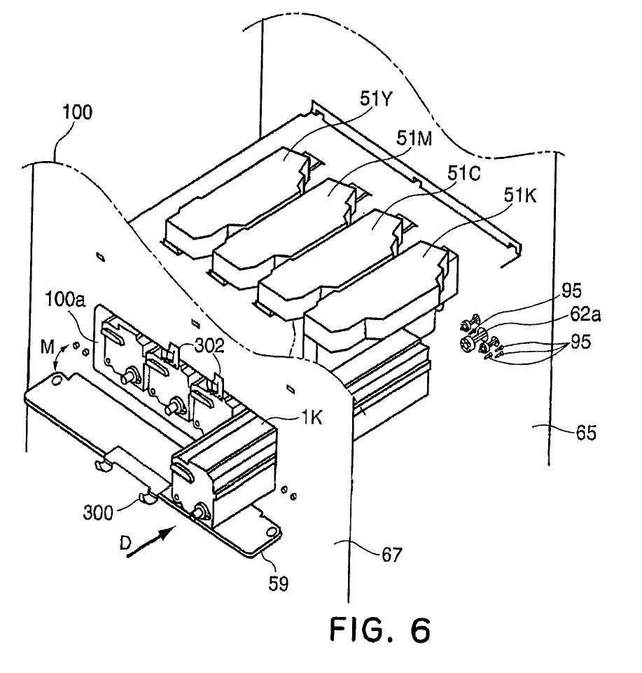

Next, referring to FIGS. 6-11, the embodiments of the present invention will be described.

Referring to FIG. 6, in this embodiment, the cartridge 1 is mounted into the apparatus main assembly 100 in the front-to-rear direction (direction indicated by an arrow mark D).

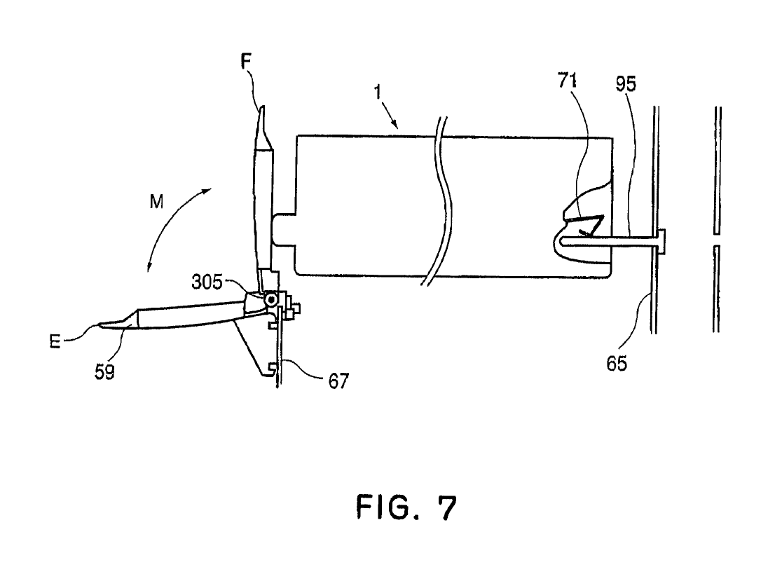

As described previously, the apparatus main assembly 100 is provided with the opening 100a for mounting or dismounting the cartridge 1. The lid 59 (opening/closing member) for covering or exposing the opening 100a rotates about the rotational center 305 (FIG. 7) in the direction indicated by an arrow mark M, exposing or covering the opening 100a.

Further, the lid 59 is provided with a pair of latching claws 300, which are on the top edge of the lid 59, whereas the top edge of the opening 100a is provided with a pair of claw catches 302, the locations of which correspond to those of the latching claws 300. The claws 300 and claw catches 302 can be engaged with, or disengaged from, each other, in order to regulate the exposing or covering of the opening 100a. Generally, the lid 59 is opened or closed by an operator.

As described above, the apparatus main assembly 100 is provided with: the opening 100a for mounting the process cartridge into the apparatus main assembly 100, or dismounting it therefrom; the front door 58 enabled to assume the closed position in which it covers the opening 100g, and the open position into which it retreats to expose the opening 100a; and the lid 59 also enabled to assume the closed position in which it covers the opening 100g, and the open position into which it retreats to expose the opening 100a. The cartridge 1 is mounted or dismounted, when the front door 58 and lid 59 are assuming their open positions. The electrical contact pin 95 as the electrical contact on the apparatus main assembly 100 side is disposed in the deepest end of the cartridge mounting space in the apparatus main assembly 100, facing the opening 100a. The electrical contact pin 95 is in the form of a round rod, and is fixed to the apparatus main assembly 100.

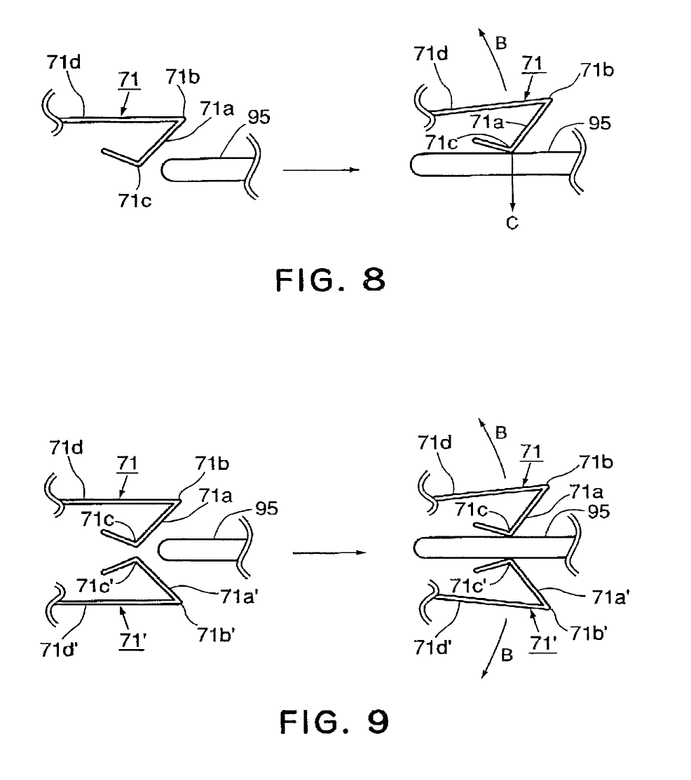

Referring to FIG. 8, a contact 71 for supplying the electrical power necessary for the processing means in cartridge 1 to the cartridge 1 from the apparatus main assembly 100 is a leaf spring, and is shaped as shown in the drawings. The electrical contact 71 (electrical contact member on the process cartridge side) is bent at a corner 51b, and an inclined portion 71a, that is, the portion beyond the corner 71b, which is bent at a point close to the tip, forming the actual electrical contact portion 71c. The contact 71 is structured so that the actual contact portion 71c is kept pressed upon the electrical contact pin 95 (electrical contact member on the apparatus main assembly side) by the resiliency of the arm portion 71d. Incidentally, in this embodiment, the development roller 4a, charge roller 3a, and brush 3h receive voltage from the apparatus main assembly 100, independently among each other. Thus, the apparatus main assembly 100 is provided with three contacts 51, and accordingly, the cartridge 1 is provided with three electrical contact pins 95.

Referring to FIGS. 6 and 7, the contact pin 95 which contacts the electrical contact 71 is located at the deepest end as seen from the opening 100a side. The contact pin 95 is fixed to the rear plate 65 of the apparatus main assembly 100, that is, the plate at the deepest end in terms of the process cartridge insertion direction, and projects toward the direction from which the process cartridge 1 is mounted into the apparatus main assembly 100, as shown in FIG. 7. The contact pin 95 is virtually parallel to the direction in which the cartridge 1 is mounted or dismounted. With the provision of the above described structural arrangement, the resistance (mounting load) to which the cartridge 1 subjected during the mounting of the cartridge 1 is smaller, compared to the resistance in a prior structural arrangement. The contact pin 95 is electrically connected to the high voltage circuit board (unshown) provided in the apparatus main assembly 100. Thus, as the contact pin 95 comes into contact with the contact 71, it becomes possible for voltage to be supplied from the high voltage circuit board on the apparatus main assembly side to the cartridge 1.

Referring to FIG. 8, as the cartridge 1 is inserted into the apparatus main assembly 100, the inclined portion 71a of the contact 71 first comes into contact with the tip of the contact pin 95 Then, as the cartridge 1 is further inserted, the inclined portion 71a of the contact 71 is pushed up by the tip of the contact pin 95. As a result, the arm portion 71d is bent in the direction indicated by an arrow mark B. Since the contact 71 is formed of elastic material (in this embodiment, metallic material), a certain amount of reactive force is generated by the resiliency of the bent arm portion 71d in the direction indicated by an arrow mark C. The actual contact portion 71c is kept pressed upon 10 the contact pin 95 by this reactive force, generating the contact pressure necessary to keep the contact 71 and contact pin 95 electrically in contact with each other. While the actual contact portion 71c and contact pin 95 are kept in contact with each other by the resiliency of the arm portion 71d, the actual contact portion 71c is pressing upon the contact pin 95 in the direction virtually perpendicular to the direction in which the cartridge 1 is mounted or dismounted. In other words, the direction in which the actual contact portion 71c presses upon the contact pin 95 is different from the direction in which the cartridge 1 is mounted into the apparatus main assembly. Therefore, the cartridge 1 is not pushed back by the contact pressure, being allowed to be smoothly mounted into the apparatus main assembly 100.

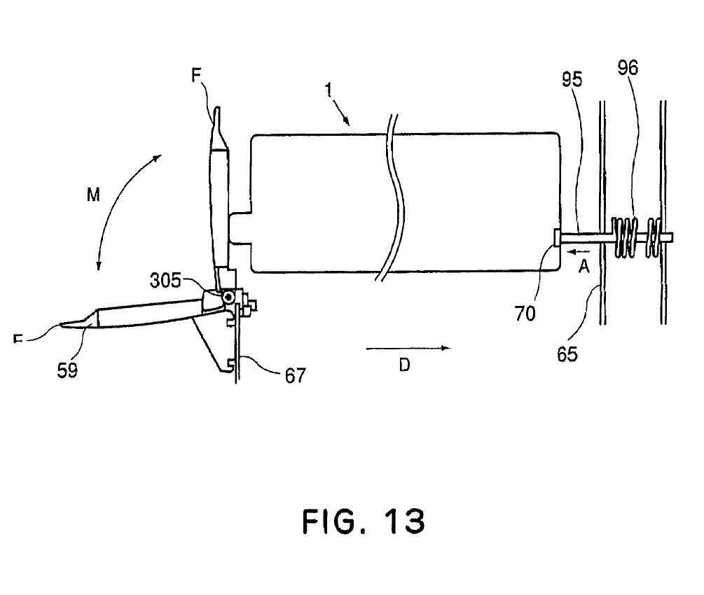

After the mounting of the cartridge 1 into the apparatus main assembly 100, the opening 100a is covered by the rotating the lid 59 about the rotational center 305. During this closing of the lid 95, the cartridge 1 is not subjected to the pressure generated by the contact spring (FIG. 13) in the direction to push the cartridge 1 outward, as is the cartridge 1 in the case of a prior apparatus structure. Thus, the lid 59 can be closed by the application of a smaller force than the lid in a prior apparatus, making it easier for a user to operate the image forming apparatus. The lid 59 is rotated until the latching claws 300 engage with the claw catches 302. This concludes the mounting of the cartridge 1 into the apparatus main assembly 100.

In order to take the cartridge 1 out of the apparatus main assembly 100, first, the claws 300 are disengaged from the claw catches. Then, the lid 59 is rotated about the rotational center 305 to expose the opening 100a. Then, the cartridge 1 is pulled out of the cartridge 1 through the opening 100a. As a result, the actual contact portion 71c is separated from the contact pin 95, dissolving the electrical connection between the cartridge 1 and apparatus main assembly 100. As the cartridge 1 is pulled out of the apparatus main assembly 100, the arm portion 71d restores its original shape due to the resiliency of the material of the contact 71.

With the provision of the above described structural arrangement, the electrical connection between the contact 71 and contact pin 95 is automatically established as the cartridge 1 is mounted into the apparatus main assembly 100. In other words, it is assured, without requiring a user to carry out complicated operations, that electrical contact is established and maintained between the cartridge 1 and apparatus main assembly 100.

Further, the direction (indicated by the arrow mark C in FIG. 8) in which the actual contact portion 71c presses on the contact pin 95 is made different from the direction (indicated by the arrow mark D in FIG. 6) in which the cartridge 1 is mounted or dismounted Therefore, the cartridge 1 is not subjected to such force that acts in the direction to push the cartridge 1 outward of the apparatus main assembly 100, eliminating the need for requiring the lid 59 to counter the pressure which acts in the direction to move the cartridge 1 outward of the apparatus main assembly 100.

As for another embodiment of the electrical contact, the cartridge 1 may be provided with two contacts 71 and 71′, which are symmetrically disposed with respect to the axial line of the contact pin 95, as shown in FIG. 9. In such a case, the structure of the cartridge 1 itself, and the method for mounting or dismounting the cartridge 1, are the same as in the above described structure in which one contact 71 is provided. Here, therefore, only the structures of the two contacts 71 and 71′ will be described. In this embodiment, the two contacts 71 and 71′ are disposed so that their actual contact portions 71c and 71′c face each other. As the cartridge 1 is inserted through the opening 100a, the contacts 71 and 71′ advance toward the contact pin 95, and the inclined portions 71a and 71′a of the contacts 71 and 71′ come into contact with the contact pin 95.

As the cartridge 1 is further inserted, the contacts 71 and 71′ are pushed, in a relative sense, by the contact pin 95 in the direction to widen the distance between the actual contact portions 71c and 71′c. As a result, the contact pin 95 is sandwiched by the actual contact portions 71c and 71′c. In this state, the pressures applied to the contact pin 95 from the top and bottom sides by the contacts 71 and 71′, respectively, are equal in magnitude, and therefore, cancel each other. Therefore, the contact pin 95 is prevented from being subjected to only the force which acts thereupon in the downward direction, or only the force which acts thereupon in the upward direction.

The contact pressures C and C′ generated by the contacts 71 and 71′ can be made to cancel each other, by disposing the two contacts 71 and 71′ in a manner to oppose each other as described above. In other words, the pressures, which act upon the contact pin 95 in the direction virtually perpendicular to the direction in which the cartridge 1 is mounted or dismounted, can be eliminated.

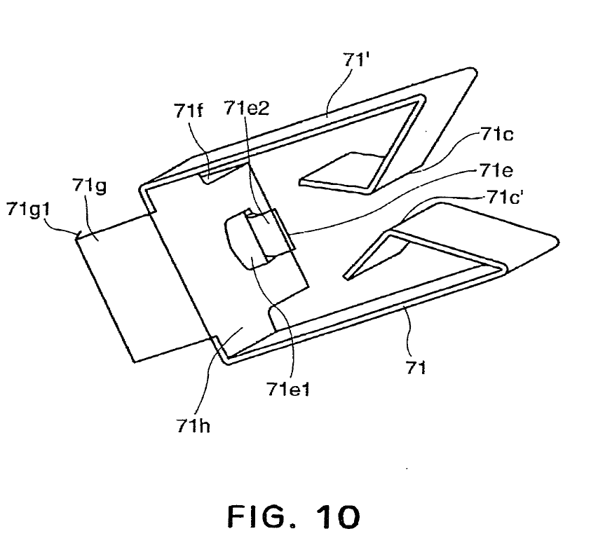

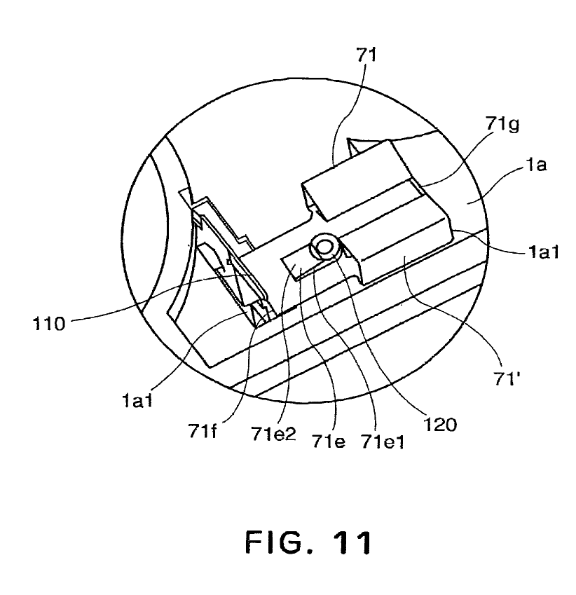

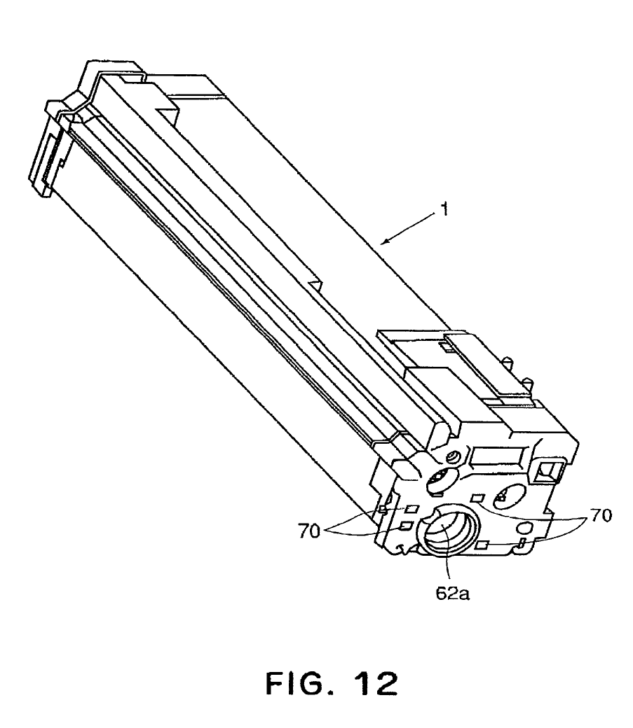

At this time, referring to FIGS. 10 and 11, the structure of the electrical contact 71 as an electrical contact member will be described in detail.

FIG. 10 is a perspective view of the electrical contact 17, and FIG. 11 is a perspective view of the electrical contact 71 fixed to the cartridge frame 1a, and its adjacencies.

The electrical contact 71 (electrical contact member) in this embodiment is such an electrical contact that establishes electrical connection between the cartridge 1 and apparatus main assembly 100, as the cartridge 1 comprising the electrophotographic photoconductive drum 2, and the processing means which act upon the photoconductive drum 2, is mounted into the apparatus main assembly 100. The electrical contact 71 is used for the cartridge 1.

This contact 71 comprises: a base portion 71h, an anchoring portion 71e, a pair of positioning portions 71f and 71g, and a pair of electrical contact portions 71c and 71′c. The anchoring portion 71e is the portion by which the base portion 71h is fixed to the frame 1a. The pair of positioning portions 71f and 71g are for accurately positioning the base portion 71h relative to the frame 1a, when fixing the base portion 71h to the frame 1a by the anchoring portion 71e. The pair of electrical contact points 71c and 71′c project from the base portion 71h. They press on the electrical contact pin 95, that is, the electrical contact on the apparatus main assembly side, to establish and maintain electrical connection between themselves and the contact pin 95, as the cartridge 1, to which the electrical contact 71 has been fixed, is mounted into the apparatus main assembly 100. The direction in which they press on the electrical contact pin 95 is different from the direction in which the cartridge 1 is mounted into the apparatus main assembly 100.

The anchoring portion 71e is provided with a hole 71e1 through which a projection 120 of the frame 1a is put, and a pressing portion 71e2 which presses the projection 120, which has been put through the hole 71e1.

The pressing portion 71e2 is a part of the base portion 71h, which is formed by cutting base portion 71h along the edge of the pattern of the pressing member 71e2 drawn on the base portion 71h, and bending the portion surrounded by the cut edge, toward the electrical contact points 71c and 71′c, along the line connecting the two ends of the cut edge. The electrical contact 71 is formed of metallic substance. Thus, the pressing portion 71e2 is kept pressed upon the peripheral surface of the projection 120, by the resiliency of the metallic substance. Therefore, the contact 71 remains held to the frame 1a by the pressing portion 71e2. Incidentally, the contact 71 can be removed from the frame 1a, by applying force to the contact 71 in the direction to cause the projection 120 to come out of the hole 71e1. In other words, the contact 71 is removably attachable to the frame 1a.

The contact 71 is formed of metallic substance such as phosphor bronze, steel, stainless steel, or the like.

The positioning portions 71f and 71g project from the base portion 71h in the direction opposite to the direction in which the actual contact portions 71c and 71′c project from the base portion 71h. They are placed in contact with the edges of the frame holes 1a1 of the frame 1a to accurately position the electrical contact 71 relative to the frame 1a.

The tip of the positioning portion 71g is bent, and this bent portion 71g1 latches onto the frame 1a, securing the contact 71 to the frame 1a. At least one of the two positioning portions 71f and 71g is provided with such a tip portion.

The positioning portions 71f and 71g are on the opposing ends of the base portion 71h, one for one, in parallel to each other and perpendicular to the base portion 71h.

Further, when the electrical contact 71 is attached to the cartridge 1, the positioning portion 71f establishes electrical connection between itself and the electrical contact 110 in connection with one of the members of the cartridge 1, which require electrical power, by coming into contact with the member.

The members of the cartridge 1, which need to be supplied with electrical power, are the aforementioned processing means: development roller 4a for developing an electrostatic latent image formed on the photoconductive drum 2, charge roller 3a for charging the photoconductive drum 2, and auxiliary charge brush 3h for charging the photoconductive drum 2.

Referring to FIG. 7, the contact 71 is disposed within the external frame, that is, the external shell, of the cartridge frame. In other words, the contact 71 is placed so that it does not protrude from the external frame of the cartridge 1. With this structural arrangement, a user is prevented from coming into contact with the contact 71, when handing the cartridge 1. Therefore, it is assured that electrical contact is established and maintained between the cartridge 1 and apparatus main assembly 100. Although only one contact 71 is shown in FIG. 7, the basic arrangement regarding the provision of two contacts 71 is similar to the above described one.

In this embodiment, the contact 71, or the contact on the cartridge side, is an elastic member, and the contact pin 95, or the contact on the apparatus main assembly side, is a rigid member solidly fixed to the apparatus main assembly 100. However, the contact 71 and contact pin 95 may be reversed in placement and material, and the reversal will provide the same effects as those provided by the original placement and material.

As described above, according to the present invention, the electrical connection between the cartridge 1 and apparatus main assembly 100 can be established as the cartridge 1 is mounted into the apparatus main assembly 100. Therefore, it is possible to assure, without requiring a user to carry out complicated operations, that electrical connection is established and maintained between the cartridge 1 and apparatus main assembly 100.

Further, the direction of the contact pressure between the contact on the cartridge side and the contact on the apparatus main assembly side is virtually perpendicular to the direction in which the cartridge is mounted or dismounted. Therefore, the cartridge is not subjected to such force that acts in the direction to push the cartridge out of the apparatus main assembly 100. Thus, it is unnecessary to substantially strengthen the lid itself, and the portion of the apparatus main assembly which rotationally supports the lid.

Further, when a user opens or closes the lid, it is unnecessary for the use to overcome the contact pressure. Therefore, the operability of the image forming apparatus in terms of the cartridge mounting efficiency is better.

The present invention could improve the operability of an image forming apparatus in terms of the efficiency with which a process cartridge is mounted into the main assembly of the image forming apparatus.

While the invention has been described with reference to the structures disclosed herein, it is not confined to the details set forth, and this application is intended to cover such modifications or changes as may come within the purposes of the improvements or the scope of the following claims.

What is claimed is:

1. An electrical contact member, usable with a process cartridge, for establishing electrical connection between the process cartridge and a main assembly of an electrophotographic image forming apparatus, when the process cartridge is mounted to the main assembly of the apparatus, the process cartridge including an electrophotographic photosensitive drum and process means actable on the photosensitive drum, said electrical contact member comprising
a base member;
a mounting portion for mounting said base member to a frame of the process cartridge;
a positioning portion for positioning said base member in said frame when said base member is mounted to the frame of said process cartridge by said mounting portion;
an electrical contact portion, projected from the base member, for establishing electrical connection with a main assembly side electrical contact member, which is provided in the main assembly of the apparatus, by pressing in a direction against the main assembly side electrical contact member when the process cartridge is mounted to the main assembly of apparatus, wherein said direction is different from a mounting direction in which the process cartridge is mounted to the main assembly of the apparatus.

2. An electrical contact member claim 1, wherein said mounting portion is provided with a hole for being penetrated by a projection provided on said frame and a pressing portion for pressing against a portion of the protection penetrated through said hole.

3. An electrical contact member claim 2, wherein said pressing portion includes a cut-and-erected portion provided by cutting and erecting said base, and wherein said electrical contact member is of metal, and said cut-and-erected portion presses against a peripheral surface of said projection by an elastic force of the metal.

4. An electrical contact member claim 1, wherein said positioning portion is projected from said base member at a side opposite from a side from which said contact portion is projected, and is contacted to an age of a frame hole formed in said frame to position said electrical contact member.

5. An electrical contact member claim 1 or 4, wherein said positioning portion is disposed opposed to said base member.

6. An electrical contact member claim 5, wherein at least a part of said positioning portion has a free end portion which is bent, and wherein said electrical contact member is mounted to said frame also by the bent portion being the locked with said frame.

7. An electrical contact member claim 1, wherein when said electrical contact member is mounted to said process cartridge, said positioning portion is contacted to an electric energy receiving contact which is electrically connected with an electric energy receiving member of said process cartridge to establish an electrical connection therebetween.

8. An electrical contact member claim 7, wherein said electric energy receiving member includes a developing roller as one of said process means for developing an electrostatic latent image followed on said photosensitive drum, a charging roller as one of said process means for electrically charging said photosensitive drum, and a charging assistance brush as one of said process means for electrically charging said photosensitive drum.

9. A process cartridge detachably mountable to a main assembly of an electrophotographic image forming apparatus, comprising:
an electrophotographic photosensitive drum;
process means actable on said photosensitive drum; and
an electrical contact portion for establishing electrical connection with a main assembly side electrical contact member, which is provided in the main assembly of the apparatus, by pressing in a direction against the main assembly side electrical contact member when the process cartridge is mounted to the main assembly of apparatus, wherein said direction is different from a mounting direction in which the process cartridge is mounted to the main assembly of the apparatus.

10. A process cartridge claim 9, wherein said electrical contact member including,
a base member;
a mounting portion for mounting said base member to a frame of the process cartridge;
a positioning portion for positioning said base member in said frame when said base member is mounted to the frame of said process cartridge by said mounting portion;
wherein said electrical contact member includes an electrical contact portion for pressing against the main assembly side electrical contact member to establish an electrical connection therewith.

11. A process cartridge claim 10, wherein said pressing portion includes a cut-and-erected portion provided by cutting and erecting said base, and wherein said electrical contact member is of metal, and said cut-and-erected portion presses against a peripheral surface of said projection by an elastic force of the metal.

12. A process cartridge claim 11, wherein said pressing portion includes a cut-and-erected portion provided by cutting and erecting said base, and wherein said electrical contact member is of metal, and said cut-and-erected portion presses against a peripheral surface of said projection by an elastic force of the metal.

13. A process cartridge claim 10, wherein said positioning portion is projected from said base member at a side opposite from a side from which said contact portion is projected, and is contacted to an age of a frame hole formed in said frame to position said electrical contact member.

14. A process cartridge claim 10 or 13, wherein said positioning portion is disposed opposed to said base member.

15. A process cartridge claim 14, wherein at least a part of said positioning portion has a free end portion which is bent, and wherein said electrical contact member is mounted to said frame also by the bent portion being the locked with said frame.

16. A process cartridge claim 11 or 14, wherein said positioning portion is contacted to an electric energy receiving contact which is electrically connected with an electric energy receiving member of said process cartridge to establish an electrical connection therebetween.

17. A process cartridge claim 16, wherein said electric energy receiving member includes a developing roller as one of said process means for developing an electrostatic latent image followed on said photosensitive drum, a charging roller as one of said process means for electrically charging said photosensitive drum, and a charging assistance brush as one of said process means for electrically charging said photosensitive drum.

18. An electrophotographic image forming apparatus, to which a process cartridge is detachably mountable, for forming an image on a recording material, comprising:
a main assembly side electrical contact member; and
a mounting portion for mounting the process cartridge, said process cartridge including;
process means actable on said photosensitive drum; and
an electrical contact portion for establishing electrical connection with a main assembly side electrical contact member, which is provided in the main assembly of the apparatus, by pressing in a direction against the main assembly side electrical contact member when the process cartridge is mounted to the main assembly of apparatus, wherein said direction is different from a mounting direction in which the process cartridge is mounted to the main assembly of the apparatus.

19. An apparatus according to claim 18, wherein said main assembly side electrical contact member is in the form of a circular column and is fixed to the main assembly of said image forming apparatus.

20. An apparatus according to claim 18, wherein the main assembly of said apparatus comprises an opening for mounting the process cartridge to the main assembly and demounting it from the main assembly, and an openable member movable between a closing position for closing the opening and an opening position retracted from the closing position, wherein said process cartridge is mounted or demounted when said openable member is in the open position, and said main assembly side electrical contact is disposed opposed to said opening at a rear position of the main assembly.

21. A process cartridge detachably mountable to a main assembly of an electrophotographic image forming apparatus, said process cartridge comprising:
an electrophotographic photosensitive drum;
process means actable on said photosensitive drum;
a base member;
a mounting portion for mounting said base member to a frame of said process cartridge;
a positioning portion for positioning said base member in said frame when said base member is mounted to the frame of said process cartridge by said mounting portion;
an electrical contact member having an electrical contact portion, projected from the base member, for establishing electrical connection with a main assembly side electrical contact member, which is provided in the main assembly of the apparatus, by pressing in a direction against the main assembly side electrical contact member when the process cartridge is mounted to the main assembly of apparatus, wherein said direction is different from a mounting direction in which the process cartridge is mounted to the main assembly of the apparatus.

22. A process cartridge claim 21, wherein said pressing portion includes a cut-and-erected portion provided by cutting and erecting said base, and wherein said electrical contact member is of metal, and said cut-and-erected portion presses against a peripheral surface of said projection by an elastic force of the metal.

23. A process cartridge claim 22, wherein said pressing portion includes a cut-and-erected portion provided by cutting and erecting said base, and wherein said electrical contact member is of metal, and said cut-and-erected portion presses against a peripheral surface of said projection by an elastic force of the metal.

24. A process cartridge claim 21, wherein said positioning portion is projected from said base member at a side opposite from a side from which said contact portion is projected, and is contacted to an age of a frame hole formed in said frame to position said electrical contact member.

25. A process cartridge claim 21 or 24, wherein said positioning portion is disposed opposed to said base member.

26. A process cartridge claim 25, wherein at least a part of said positioning portion has a free end portion which is bent, and wherein said electrical contact member is mounted to said frame also by the bent portion being the locked with said frame.

27. A process cartridge claim 21, wherein said positioning portion is contacted to an electric energy receiving contact which is electrically connected with an electric energy receiving member of said process cartridge to establish an electrical connection therebetween.

28. A process cartridge claim 27, wherein when said electrical contact member is mounted to said process cartridge, said positioning portion is contacted to an electric energy receiving contact which is electrically connected with an electric energy receiving member of said process cartridge to establish an electrical connection therebetween.
